(19) United States
(12) Patent Application Publication
(10) Pub. No.: US 2008/0192712 A1
(43) Pub. Date: Aug. 14, 2008

(54) DATA PROCESSING APPARATUS AND POWER CONTROL METHOD THEREOF

(75) Inventor: Seong-geun PARK, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/758,350

(22) Filed: Jun. 5, 2007

(30) Foreign Application Priority Data
Jul. 31, 2006 (KR) 2006-72316

(51) Int. Cl. H04L 12/50

(52) U.S. Cl. 370/338

(57) ABSTRACT

A data processing apparatus includes a connecting part to which a WiBro (Wireless Broadband Internet) module and a wireless LAN module are connected, a WiBro module driver that enables the WiBro module to operate. A communication controller includes the WiBro module driver and controls the WiBro module and the wireless LAN module to transmit/receive data. A power supply supplies power to the WiBro module and the wireless LAN module. A power controller, if the WiBro module driver is executed while the WiBro module is connected to the connecting part, controls the power supply to supply power to the WiBro module and prevents power from being supplied to the wireless LAN module.

### CROSS-REFERENCE TO RELATED APPLICATION

This application claims the benefit of Korean Application No. 2006-72316, filed Jul. 31, 2006 in the Korean Intellectual Property Office, the disclosure of which is incorporated herein by reference.

### BACKGROUND OF THE INVENTION

1. Field of the Invention

Aspects of the present invention relate to a data processing apparatus and a power control method thereof, and more particularly, to a data processing apparatus, which is capable of reducing power consumption depending on connection or use of a communication module, and a power control method thereof.

2. Description of the Related Art

In recent years, communication modules of various standards have been developed with the rapid development of communication technologies. Among these modules, a wireless Local Area Network (LAN) employing a radio wave or infrared wave transmission system is being widely used for a portable computer (such as a laptop computer). The wireless LAN (WLAN) enables transmission/receipt of data without any wired connection. Although the wireless LAN is relatively inexpensive, it is impossible to be used when the portable computer moves at a high speed or is far away from an Access Point (AP).

As one of communication modules for overcoming such a disadvantage of the wireless LAN, a Wireless Broadband Internet (WiBro) module has been developed. The WiBro module can access Internet and transmit/receive various data at a high transmission speed using a mobile terminal while stopping or moving. Although the WiBro module is more expensive than the wireless LAN, the WiBro module is being spotlighted as a data service because of the data transmission/receipt at a high data transmission speed while moving at a high speed and its usability even when far away from an AP.

When such communication modules of different standards are connected to or incorporated into a portable computer or the like, disadvantages of the respective communication modules can be overcome. However, when both modules are used, a battery must be used for the communication modules, which are connected to or incorporated in the mobile terminal. This arrangement may consume power greatly as compared to when only one communication module is connected to or incorporated into the portable computer. Accordingly, there is a need for a technique which is capable of reducing power consumption when two or more communication modules are used in a portable computer.

### SUMMARY OF THE INVENTION

Accordingly, it is an aspect of the present invention to provide a data processing apparatus, which is capable of connecting two communication modules of different standards, (such as a WiBro module and a wireless LAN) to the data processing apparatus in order to complementarily overcome disadvantages of the two communication modules, and a power control method thereof.

It is another aspect of the present invention to provide a data processing apparatus, which is capable of reducing power consumption by preventing power from being supplied to an unused one of two communication modules, for example, a WiBro module and a wireless LAN, connected to the data processing apparatus, and a power control method thereof.

Additional aspects and/or advantages of the invention will be set forth in part in the description which follows and, in part, will be obvious from the description, or may be learned by practice of the invention.

The foregoing and/or other aspects of the present invention can be achieved by providing a data processing apparatus comprising: a connecting part to which a WiBro (Wireless Broadband Internet) module and a wireless LAN module are connected; a WiBro module driver that enables the WiBro module to operate; a communication controller that comprises the WiBro module driver and controls the WiBro module and the wireless LAN module to transmit/receive data; a power supply that supplies power to the WiBro module and the wireless LAN module; and a power controller that, if the WiBro module driver is executed in a state that the WiBro module is connected to the connecting part, controls the power supply to supply power to the WiBro module and prevent power from being supplied to the wireless LAN module.

According to the exemplary embodiment of the present invention, if the WiBro module driver is not executed in a state that the wireless LAN module is connected to the connecting part, the power controller controls the power supply to supply power to the wireless LAN module and prevent power from being supplied to the WiBro module.

The foregoing and/or other aspects of the present invention can be achieved by providing a data processing apparatus comprising: a WiBro module; a wireless LAN module; a WiBro module driver that enables the WiBro module to operate; a communication controller that comprises the WiBro module driver and controls the WiBro module and the wireless LAN module to transmit/receive data; a power supply that supplies power to the WiBro module and the wireless LAN module; and a power controller that, if the WiBro module driver is executed, controls the power supply to supply power to the WiBro module and prevent power from being supplied to the wireless LAN module.

According to the exemplary embodiment of the present invention, when the WiBro module driver is not executed, the power controller controls the power supply to supply power to the wireless LAN module and prevent power from being supplied to the WiBro module.

According to the exemplary embodiment of the present invention, the communication controller further comprises a WiBro module controller and a wireless module controller that control the WiBro module and the wireless LAN module to transmit/receive data, respectively, and wherein, if the WiBro module driver is executed in the state that the WiBro module is connected to the connecting part, the power controller controls the power supply to supply power to the WiBro module controller and prevent power from being supplied to the wireless LAN module controller.

According to the exemplary embodiment of the present invention, if the WiBro module driver is not executed in a state that the wireless LAN module is connected to the connecting part, the power controller controls the power supply to supply power to the wireless LAN module controller and prevent power from being supplied to the WiBro module controller.

According to the exemplary embodiment of the present invention, the communication controller further comprises a WiBro module controller and a wireless module controller that control the WiBro module and the wireless LAN module to transmit/receive data, respectively, and wherein, if the WiBro module driver is executed, the power controller controls the power supply to supply power to the WiBro module controller and prevent power from being supplied to the wireless LAN module controller.

According to the exemplary embodiment of the present invention, if the WiBro module driver is not executed, the power controller controls the power supply to supply power to the wireless LAN module controller and prevent power from being supplied to the WiBro module controller.

According to the exemplary embodiment of the present invention, the data processing apparatus further comprises a user input part that receives an instruction to operate the WiBro module driver from a user, wherein, if the WiBro module driver operates according to the instruction received by the user input part, the power controller controls the power supply to supply power to the WiBro module.

According to the exemplary embodiment of the present invention, the data processing apparatus further comprises a display part that displays a state of data transmission/receipt of one of the WiBro module and the wireless LAN module, wherein the communication controller controls the display part to display the data transmission/receipt state of one of the WiBro module and the wireless LAN module.

According to the exemplary embodiment of the present invention, the data processing apparatus comprises a portable computer.

According to the exemplary embodiment of the present invention, the communication controller comprises an initialization routine executing part that executes an initialization routine for the data processing apparatus and sets whether a user operates the WiBro module driver if the initialization routine is executed.

The foregoing and/or other aspects of the present invention can be achieved by providing a power control method of a data processing apparatus, comprising: connecting a WiBro module and a wireless LAN module to the data processing apparatus; executing a WiBro module driver that enables the WiBro module to operate; and supplying power to the WiBro module and preventing power from being supplied to the wireless LAN module, if the WiBro module driver is executed.

According to the exemplary embodiment of the present invention, the supplying the power to the WiBro module and preventing the power from being supplied to the wireless LAN module comprises, if the WiBro module driver is not executed, supplying power to the wireless LAN module and preventing power from being supplied to the WiBro module.

According to the exemplary embodiment of the present invention, the power control method further comprises receiving an instruction to execute the WiBro module driver from a user, wherein the WiBro module driver is executed according to the instruction received from the user.

According to the exemplary embodiment of the present invention, the data processing apparatus comprises a portable computer.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 and 2 are block diagrams of a data processing apparatus according to an embodiment of the present invention;

FIG. 3 is a block diagram of a data processing apparatus according to an embodiment of the present invention; and

FIG. 4 is a flow chart illustrating an operation of a data processing apparatus according to an embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to like elements throughout. The embodiments are described below in order to explain the present invention by referring to the figures.

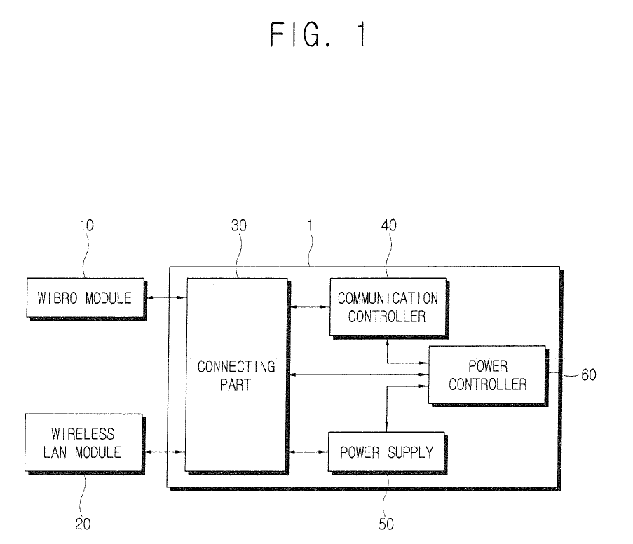

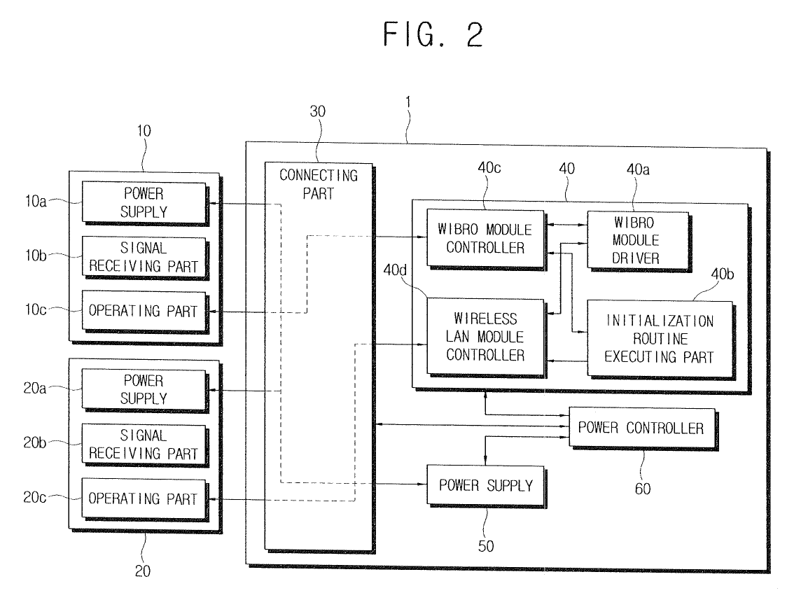

FIGS. 1 and 2 are block diagrams of a data processing apparatus 1 according to an embodiment of the present invention. The data processing apparatus 1 is an apparatus that receives data from an outside source and processes the received data through predetermined application programs. Examples of the apparatus may be embodied by a portable computer, a notebook computer, a Personal Digital Assistant (PDA), a portable media player, a telephone, a display, and/or non portable equivalents thereof. As shown in FIG. 1, the data processing apparatus 1 comprises a connecting part 30. A WiBro module 10 and a wireless LAN module 20 having different communication standards are detachably connected to the connecting part 30. The apparatus 1 also includes a communication controller 40, a power supply 50 and a power controller 60. While not required, it is understood that other elements, such as displays or input devices, can be included in the apparatus 1, and that other wireless modules can be included in addition to or instead of the modules 10 and/or 20.

The data processing apparatus 1 has an additional function such as wireless Internet or wireless communication through the WiBro module 10 and the wireless LAN module 20 connected thereto. As shown in FIG. 2, the WiBro module 10 comprises a power supply 10a, a signal receiving part 10b, and an operating part 10c. The wireless LAN module 20 comprises a power supply 20a, a signal receiving part 20b, and an operating part 20c. The power supplies 10a and 20a are supplied with power from the power supply 50 and power the signal receiving parts 10b and 20b and the operating parts 10c and 20c. The signal receiving parts 10b and 20b transmit/receive data via an internal antenna (not shown) or an external antenna (not shown). The operating parts 10c and 20c exchange data with the communication controller 40 and process signals. While not required in all aspects, the power supplies 10a and 20a can be power storage devices and/or interfaces through which power from the power supply 50 are received at the modules 10, 20.

The WiBro module 10 transmits/receives data at a frequency of a 2.3 GHz band, and the wireless LAN module 20 transmits/receives data at a frequency of a 2.4 GHz band. Therefore, even if these communication modules 10 and 20 have respective main antennas, it is possible to share an auxiliary antenna by connecting the auxiliary antenna to both of the communication modules 10 and 20 in other embodiments.

The connecting part 30 transmits data from the outside by a Peripheral Component Interconnect (PCI)-Express interface or a Universal Serial Bus (USB) interface to the data processing apparatus 1 via the WiBro module 10 or the wireless LAN module 20, and also transmits data produced from the data processing apparatus 1 to the outside via the WiBro module 10 or the wireless LAN module 20. However, it is understood that the connection can be through other standards, such as IEEE 1394 connections, or through later iterations of the standard, such as such as USB 2.0, or the like.

The connecting part 30 with the PCI-Express interface or the USB interface supports a plug and play function to enable use of the communication module 10 or 20 without any separate process if the communication module 10 or 20 is connected thereto. Therefore, when a powered-off communication module 10 or 20 is powered on, information related to the communication module 10 or 20 can be maintained. That is, the data processing apparatus 1 need not find the information related to the communication module 10 or 20. However, it is understood that this feature is not required in all aspects.

The communication controller 40 controls components of the WiBro module 10 and the wireless LAN module 20, and processes data exchange between the communication modules 10 and 20 and the data processing apparatus 1 and/or, between an external source outside and the communication modules 10 and 20.

In this embodiment, the communication controller 40 comprises a WiBro module driver 40a, an initialization routine executing part 40b, a WiBro module controller 40c and a wireless LAN module controller 40d. The WiBro module driver 40a refers to an application that allows the WiBro module 10 to conduct communication. An example of such an application is a WiBro Connection Manager (WCN) application. For example, when the WCN application is executed according to a user's instruction, the WCN application controls the WiBro module 10 to be driven. Then, the power controller 60 controls the power supply 50 to supply power to only the WiBro module 10 and prevents power from being supplied to the wireless LAN module 20. Accordingly, power consumption can be reduced by supplying the power to only the WiBro module 10 even when both of the WiBro module 10 and the wireless LAN module 20 are connected to the data processing apparatus 1. However, it is understood that the module driver 40c can be included in a more general software package in addition to or instead of in a driver.

In addition, while the power supply 50 is supplying the power to the WiBro module 10, the WiBro module driver 40a may determine whether or not data can be transmitted/received to/from the WiBro module 10. If it is determined that the data cannot be transmitted/received to/from the WiBro module 10, the power controller 60 can control the power supply 50 to prevent the power from being supplied to the WiBro module 10.

According to another aspect of the invention, the initialization routine executing part 40b may set whether or not the WiBro module 10 or the wireless LAN module 20 is used by default when executing an initialization routine. For example, if the initialization routine executing part 40b is a Basic Input/Output System (BIOS) program, a user may set whether or not one of the communication modules 10, 20 is used at a BIOS setup step when the mobile device (such as a computer) is initially booted. Accordingly, the data processing apparatus 1 can prevent power from being supplied to an unintended module between the WiBro module 10 and the wireless LAN module 20 at the initial booting. However, it is understood that this aspect is not required in all aspects of the invention.

The communication controller 40 including the WiBro module controller 40c and the wireless LAN module controller 40d detects whether or not the communication modules 10 or 20 are connected to the data processing apparatus 1. If the WiBro module 10 is not connected to the data processing apparatus 1, the communication controller 40 disables the WiBro module controller 40c. If the wireless LAN module 20 is not connected to the data processing apparatus 1, the communication controller 40 disables the wireless LAN module controller 40d, thereby minimizing power consumption.

According to an aspect of the invention, if the WiBro module driver 40a is executed while the WiBro module 10 is connected to the connecting part 30, the power controller 60 controls the power supply 50 to supply power to the WiBro module controller 40c and prevents power from being supplied by the power supply 50 to the wireless LAN module controller 40d. Conversely, if the WiBro module driver 40a is not executed while the wireless LAN module 20 is connected to the connecting part 30, the power controller 60 controls the power supply 50 to supply power to the wireless LAN module controller 40d and prevents power from being supplied by the power supply 50 to the WiBro module controller 40c.

The power supply 50 supplies power required for driving of the data processing apparatus 1, and further supplies power required for driving of the WiBro module 10 and the wireless LAN module 20 independent from each other. The power supply 50 can be a battery, a fuel cell, or other like power storage and/or generation unit. Moreover, it is understood that the power can be externally supplied to the apparatus 1 in addition to or instead of by the power supply 50 such that the power supply 50 can also be or include an interface through which the power is received.

When the WiBro module 10 or the wireless LAN module 20 is connected to the data processing apparatus 1, the power controller 60 controls the power supply 50 to supply power to the connected communication module 10 or 20. The WiBro module 10 is different in frequency band from the wireless LAN module 20. Accordingly, when the WiBro module driver 40a drives the WiBro module 10 to enable data transmission/receipt, it is preferable that power is supplied to the WiBro module 10 and power is prevented from being supplied to the wireless LAN module 20. In contrast, when the WiBro module driver 40a is not executed, it is preferable that power is supplied to the wireless LAN module 20 and power is prevented from being supplied to the WiBro module 10. To be brief, the power controller 60 can control the power supply 50 to supply power to only a communication module 10, 20 that allows data to be transmitted/received. Thus, if both modules 10, 20 are connected, the controller 60 selects which module 10, 20 to power and which not to power.

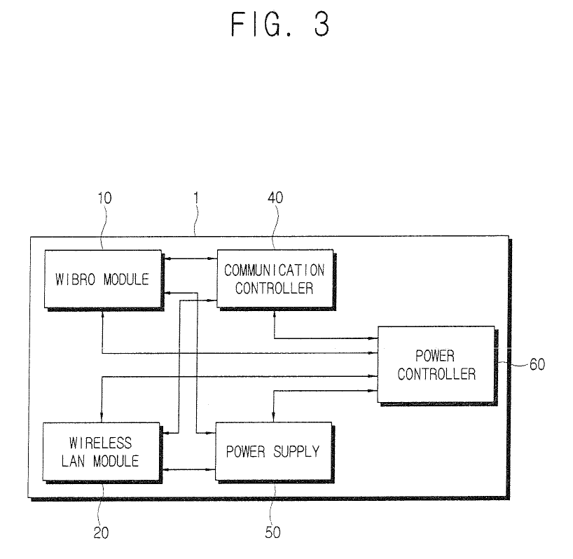

Hereinafter, a data processing apparatus 2 according to another embodiment of the present invention will be described with reference to FIG. 3. The data processing apparatus 2 incorporates the WiBro module 10 and the wireless LAN module 20 and has the same configuration as the data processing apparatus 1 of the first embodiment except that the connecting part 30 is excluded from the data processing apparatus 1. However, it is understood that the connecting part 30 can be used if a further module is used in addition to the modules 10, 20 incorporated into the data processing apparatus 2.

In the data processing apparatus 2 incorporating the two communication modules 10 and 20, when the WiBro module driver 40a is executed, the communication controller 40 allows the power controller 60 to control the power supply 50 to supply power to the WiBro module 10 and prevent power from being supplied to the wireless LAN module 20. In contrast, when the WiBro module driver 40a is not executed, the communication controller 40 allows the power controller 60 to control the power supply 50 to supply power to the wireless LAN module 20 and prevent power from being supplied to the WiBro module 10. Thus, even when the data processing apparatus 2 incorporates both of the WiBro module 10 and the wireless LAN module, power is prevented from being supplied to an unused communication module 10 or 20, thereby reducing power consumption.

In addition, when the WiBro module driver 40a is executed in the data processing apparatus 2, the communication controller 40 disables the wireless LAN module controller 40d. When the WiBro module driver 40a is not executed, the communication controller 40 disables the WiBro module controller 40c, thereby minimizing power consumption.

According to an aspect of the invention, the communication controller 40 further comprises a WiBro module controller 40c that controls the WiBro module 10 to transmit/receive data, and a wireless LAN module controller 40d that controls the wireless LAN module 20 to transmit/receive data. If the WiBro module driver 40a is executed, the power controller 60 controls the power supply 50 to supply power to the WiBro module controller 40c and prevents power from being supplied by the power supply 50 to the wireless LAN module controller 40d. Conversely, if the WiBro module driver 40a is not executed, the power controller 60 controls the power supply 50 to supply power to the wireless LAN module controller 40d and prevents power from being supplied by the power supply 50 to the WiBro module controller 40c.

The data processing apparatuses 1 and 2 according to the embodiments shown in FIGS. 1 and 3 may further comprise a display part (not shown) that displays a state of data transmission/receipt of the communication modules 10 and 20. A user may understand the data transmission/receipt state of the communication modules 10 and 20 through the display part. Also, in the data processing apparatus 2 incorporating both of the WiBro module 10 and the wireless LAN module 20, the WiBro module 10 and the wireless LAN module 20 can share the display part. The display part may be embodied by an LED, an LCD or the like.

In addition, the data processing apparatuses 1 and 2 may further comprise a user input part (not shown) that receives an instruction related to an operation of the WiBro module 10 and the wireless LAN module 20 from a user. When the WiBro module 10 and the wireless LAN module 20 are connected to the data processing apparatus 1 or incorporated in the data processing apparatus 2, the power controller 60 can control the power supply 50 to supply power to only a communication module instructed to operate through the user input part and prevent power from being supplied to a communication module instructed not to operate. In the embodiments, the user input part may be embodied by a keyboard, a mouse or the like, or may be displayed as a user interface in the form of a message box on a display (not shown) or a touch screen display of the data processing apparatuses 1 and 2.

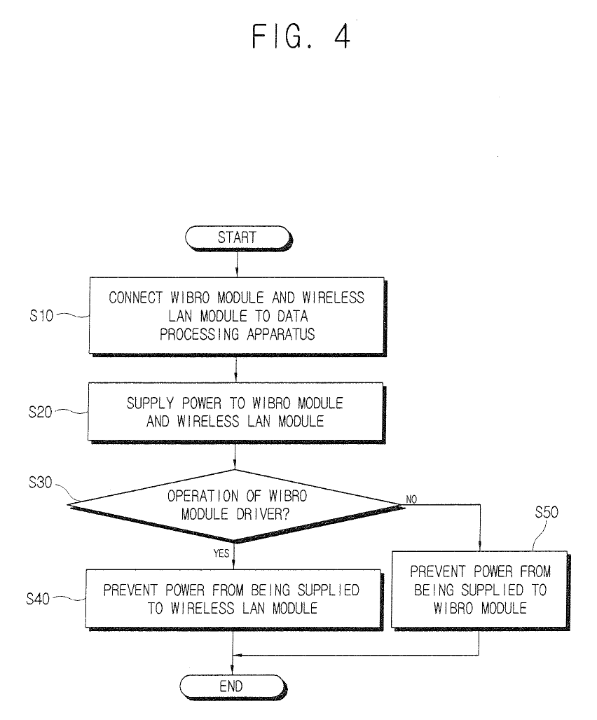

Hereinafter, a control method of the data processing apparatus 1 will be described with reference to FIG. 4. The communication controller 40 determines whether or not the WiBro module 10 or the wireless module 20 is connected to the data processing apparatus 1 at operation S10. If it is determined at the operation S10 that the WiBro module 10 or the wireless module 20 is connected to the data processing apparatus 1, the power controller 60 controls the power supply 50 to supply power to the WiBro module 10 and the wireless LAN module 20 at operation S20. Next, the power controller 60 determines whether or not the WiBro module driver 40a is executed at operation S30. If it is determined at the operation S30 that the WiBro module driver 40a is executed, the power controller 60 controls the power supply 50 to prevent power from being supplied to the wireless LAN module 20 at operation S40. In contrast, if it is determined at the operation S30 that the WiBro module driver 40a is not executed, the power controller 60 controls the power supply 50 to prevent power from being supplied to the WiBro module 10 at operation S50. While not required, operation S30 can be repeated at later times, such as where a stronger wireless LAN/WiBro connection is later found such that the apparatus 1 needs to switch modules 10, 20.

While not required in all aspects, the operation S20 may further comprise receiving an instruction to execute the WiBro module driver 40a from a user. Upon receiving the instruction to execute the WiBro module driver 40a from the user, the communication controller 40 controls the WiBro module driver 40a to be executed. Accordingly, the power controller 60 controls the power supply 50 to supply power to the WiBro module 10 and prevent power from being supplied to the wireless LAN module 20.

While described in operation S30 that the WiBro module driver 40a is checked, it is also possible that a WLAN driver (not shown) could instead be checked and the corresponding WLAN/WiBro modules 10, 20 powered according to the operating state of the WLAN driver.

As is apparent from the above description, aspects of the present invention provides a data processing apparatus, which is capable of connecting two communication modules of different standards to the data processing apparatus in order to complementarily overcome disadvantages of the two communication modules, and a power control method thereof. Examples of the standards include WLAN and WiBro, but can be other standards such as WiMax.

In addition, aspects of the present invention to a data processing apparatus, which is capable of reducing power consumption by preventing power from being supplied to an unused one of two communication modules of different standards, for example, a WiBro module and a wireless LAN, connected to the data processing apparatus, and reducing costs by allowing the two communication modules to share an antenna and an display part.

While not required, it is understood that aspects of the invention can be implemented as software encoded on a computer readable medium.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. A data processing apparatus comprising:
a connecting part to which a Wireless Broadband Internet (WiBro) module and a wireless Local Area Network (LAN) module are detachably connected;
a communication controller that comprises a WiBro module driver and controls the WiBro module and the wireless LAN module to transmit/receive data, the WiBro module driver enabling the WiBro module to operate;
a power supply that selectively supplies power to the WiBro module and the wireless LAN module; and
a power controller that, if the WiBro module driver is executed while the WiBro module is connected to the connecting part, controls the power supply to supply power to the WiBro module and prevents power from being supplied by the power supply to the wireless LAN module.

2. The data processing apparatus according to claim 1, wherein, if the WiBro module driver is not executed while the wireless LAN module is connected to the connecting part, the power controller controls the power supply to supply power to the wireless LAN module and prevents power from being supplied by the power supply to the WiBro module.

3. A data processing apparatus comprising:
a Wireless Broadband Internet (WiBro) module;
a wireless Local Area Network (LAN) module;
a communication controller that comprises a WiBro module driver and controls the WiBro module and the wireless LAN module to transmit/receive data, the WiBro module driver enabling the WiBro module to operate;
a power supply that selectively supplies power to the WiBro module and the wireless LAN module; and
a power controller that, if the WiBro module driver is executed, controls the power supply to supply power to the WiBro module and prevents power from being supplied by the power supply to the wireless LAN module.

4. The data processing apparatus according to claim 1, wherein
the communication controller further comprises a WiBro module controller that controls the WiBro module to transmit/receive data, and a wireless LAN module controller that control the wireless LAN module to transmit/receive data, and
if the WiBro module driver is executed while the WiBro module is connected to the connecting part, the power controller controls the power supply to supply power to the WiBro module controller and prevents power from being supplied by the power supply to the wireless LAN module controller.

5. The data processing apparatus according to claim 4, wherein, if the WiBro module driver is not executed while the wireless LAN module is connected to the connecting part, the power controller controls the power supply to supply power to the wireless LAN module controller and prevents power from being supplied by the power supply to the WiBro module controller.

6. The data processing apparatus according to claim 1, further comprising a user input part that receives an instruction to operate the WiBro module driver from a user,
wherein, if the WiBro module driver operates according to the instruction received by the user input part, the power controller controls the power supply to supply power to the WiBro module.

7. The data processing apparatus according to claim 1, further comprising a display part that displays a state of data transmission/receipt of one of the WiBro module and the wireless LAN module,
wherein the communication controller controls the display part to display the data transmission/receipt state of one of the WiBro module and the wireless LAN module.

8. The data processing apparatus according to claim 3, wherein the communication controller comprises an initialization routine executing part that executes an initialization routine for the data processing apparatus and sets whether a user operates the WiBro module driver if the initialization routine is executed.

9. The data processing apparatus according to claim 1, wherein
the communication controller further comprises a WiBro module controller that controls the WiBro module to transmit/receive data and a wireless LAN module controller that controls the wireless LAN module to transmit/receive data,
if the WiBro module is not connected to the connecting part, the WiBro module controller is disabled to prevent power from being supplied by the power supply to the WiBro module controller, and
if the wireless LAN module is not connected to the connecting part, the wireless LAN module controller is disabled to prevent power from being supplied by the power supply to the wireless LAN module controller.

10. A data processing apparatus comprising:
a first wireless module which wirelessly transmits data with respect to an external source according to a first communication standard;
a second wireless module which wirelessly transmits data with respect to an external source according to a second communication standard;
a communication controller that comprises a module driver and controls the first and second wireless modules to transmit/receive data, the module driver enabling one of the first and second wireless modules to operate; and
a power controller that, if the module driver is executed, supplies power to the one of the first and second wireless modules and prevents power from being supplied to the other one of the first and second wireless modules.

11. The data processing apparatus of claim 10, further comprising a power supply which selectively supplies the power to the first and second wireless modules according to the power controller.

12. The data processing apparatus of claim 10, further comprising a connecting part to which the first and second wireless modules are detachably connected to the apparatus.

13. The data processing apparatus of claim 12, wherein:
the communication controller further comprises a first module controller to control the first wireless module and a second module controller to control the second wireless module,
if the first wireless module is detached from the connecting part, the first module controller is disabled so as to not use the power, and
if the second wireless module is detached from the connecting part, the second module controller is disabled so as to not use the power.

14. A power controller system for a data processing apparatus using a first wireless module which wirelessly transmits data with respect to an external source according to a first communication standard, and a second wireless module which wirelessly transmits data with respect to an external source according to a second communication standard, the power controller comprising:
a communication controller that comprises a module driver and controls the first and second wireless modules to transmit/receive data, the module driver enabling one of the first and second wireless modules to operate; and
a power controller that, if the module driver is executed, supplies power to the one of the first and second wireless modules and prevents power from being supplied to the other one of the first and second wireless modules.

15. The power controller system of claim 14, further comprising a power supply which selectively supplies the power to the first and second wireless modules according to the power controller.

16. The power controller system of claim 15, wherein the power supply is a battery included in the apparatus.

17. The power controller system of claim 14, wherein:
the communication controller further comprises a first module controller to control the first wireless module and a second module controller to control the second wireless module,
if the communication controller determines that the first wireless module is detached from the apparatus, the first module controller is disabled so as to not use the power, and
if the communication controller the second wireless module is detached from the apparatus, the second module controller is disabled so as to not use the power.

18. The power controller system of claim 14, wherein:
the communication controller further comprises a first module controller to control the first wireless module and a second module controller to control the second wireless module,
if the module driver is executed while the one of the first and second wireless modules is connected to the apparatus, the power controller controls the power to be supplied power to the one of the first and second module controllers associated with the one wireless module and prevents the power from being supplied to the other one of the first and second module controllers.

19. The power controller system of claim 18, wherein, if the module driver is not executed while the other one of the first and second wireless modules is connected to the apparatus, the power controller controls the power to be supplied to other one wireless module controller and prevents the power from being supplied to the one module controller.

20. A power control method of a data processing apparatus using a first wireless module which wirelessly transmits data with respect to an external source according to a first communication standard, and a second wireless module which wirelessly transmits data with respect to an external source according to a second communication standard, the method comprising:
executing a module driver that enables the one of the first and second wireless modules to operate;
when the module driver is executed, supplying power to the one wireless module to allow wireless transmission using the one wireless module and preventing power from being supplied to the other one of the first and second wireless modules; and
when the module driver is not executed, supplying power to the other one wireless module to allow wireless transmission using the other one wireless module and preventing power from being supplied to the one wireless module.

21. The power control method of claim 20, further comprising:
connecting the one wireless module to the apparatus while the other wireless module is disconnected; and
disabling a module controller used by the other wireless module to not use the power.

22. The power control method of claim 20, further comprising receiving an instruction to execute the module driver, wherein the executing the module driver comprises executing the module driver according to the instruction.

23. The power control method of claim 22, wherein the receiving the instruction comprises receiving the instruction through a user interface.

24. The power control method of claim 22, wherein the receiving the instruction comprises executing a boot up operation to boot the apparatus and receiving the instruction as one of the start up sequences included in the of the boot up operation.

25. A computer readable medium encoded with processing instructions for implementing the power control method of claim 20 performed by a computer.
